(19) United States
(12) Patent Application Publication
(10) Pub. No.: US 2026/0138859 A1
(43) Pub. Date: May 21, 2026

(54) BUTTON EDGE-CUTTING CAN OPENER

(71) Applicant: Gongping LUO, Guangdong (CN)

(72) Inventor: Gongping LUO, Guangdong (CN)

(21) Appl. No.: 18/990,906

(22) Filed: Dec. 20, 2024

(30) Foreign Application Priority Data
Nov. 19, 2024 (CN) 202411648201.2

(51) Int. Cl. B67B 7/46

(52) U.S. Cl. CPC B67B 7/34; B67B 2007/303

(57) ABSTRACT

The present invention discloses a button edge-cutting can opener, comprising a main body, a button, a driving unit, and a cutting unit, wherein the button is rotatably connected to the main body through the driving unit and provided with a pressing portion, the cutting unit is mounted on the main body, the driving unit comprises a cone rod, which has a driving shaft and a cone disc, the cone disc is connected to one end of the driving shaft, a boss is arranged on the cone disc, 28 to 36 gear teeth are distributed on a side wall of the boss in an evenly spaced manner, an end portion of each of the gear teeth extends towards the cone disc, and a smooth surface is formed between the extended end portion and an edge of the cone disc.

### CROSS-REFERENCE TO RELATED APPLICATION

This application claims the priority benefit of China application serial no. 202411648201.2, filed on Nov. 19, 2024. The entirety of the above-mentioned patent application is hereby incorporated by reference herein and made a part of this specification.

### BACKGROUND

### Technical Field

The present invention pertains to the technical field of daily life tools, and particularly relates to a button edge-cutting can opener.

### Description of Related Art

In daily life, there are various kinds of canned food products, most of which are packaged in tin cans. When consuming any of these kinds of canned food products, one needs to cut open a lid with a blade tool to take out food. Therefore, there are various kinds of can openers on the market, wherein edge-cutting can openers are divided into two categories: single-handle can openers and double-handle can openers. At present, an edge-cutting can opener of this kind generally has a drive cone rod, on which gear teeth are arranged. In the course of opening a can, the gear teeth of the drive cone rod will bite a can lid tightly, leave teeth marks on the can lid, and generate a relatively large frictional force through the teeth marks. When the drive cone rod rotates, the can lid can be driven to rotate, so as to achieve the functions of cutting the lid and opening the can.

However, in the prior art, the can-locking action of the single-handle edge-cutting can opener at the beginning is not user-friendly for a first-time user and cannot be performed without training, while it is also inconvenient to perform the operation of separating two handles with one hand in the course of unlocking the double-handle edge-cutting can opener. In addition, since a relatively large number of teeth (40-48 teeth) are arranged on a drive cone rod of a can opener in the prior art such as Chinese patent 202322577813.4, when the drive cone rod rotates, front and rear gear teeth leave teeth marks that do not overlap, and are subjected to displacement and sliding in a certain degree (as shown in FIG. 12 and FIG. 13); as a result, the can lid is scratched, and iron filings are generated; the iron filings may fall into the food, thereby leading to poor food safety; moreover, the larger the displacement and sliding of the gear teeth, the more iron filings will be generated. Given the above problem, it is urgent to improve the can opener in the prior art.

### SUMMARY

It is an objective of the present invention to provide a button edge-cutting can opener that is simple to operate and easy to learn and master, and can effectively reduce the generation of iron filings and improve the food safety.

To solve the above technical problem, the present invention can be realized by using the following technical solution:
a button edge-cutting can opener, comprising a main body, a button, a driving unit, and a cutting unit, wherein the button is rotatably connected to the main body through the driving unit and provided with a pressing portion, the cutting unit is mounted on the main body and kept in a state of engaging with the driving unit, the driving unit comprises a cone rod, which has a driving shaft and a cone disc, the cone disc is connected to one end of the driving shaft, a boss is arranged on the cone disc, 28 to 36 gear teeth are distributed on a side wall of the boss in an evenly spaced manner, an end portion of each of the gear teeth extends towards the cone disc, and a smooth surface is formed between the extending end portion and an edge of the cone disc. The button edge-cutting can opener in the present invention can be formed by creatively shortening an upper handle of the double-handle edge-cutting can opener in the prior art, designing it as a button, and arranging a pressing portion on the button, which makes the structure thereof simple and the design reasonable.

In one of the embodiments, an operation identification unit is arranged on the main body, the operation identification unit comprises identification positioning backup plates and an abutment plate, the identification positioning backup plates are arranged in two groups, which are respectively located on both sides of the cone disc, and the two groups of identification positioning backup plates are arranged to be opposite to each other and have end portions in an arc shape.

In one of the embodiments, a reinforcement member is arranged inside the identification positioning backup plates and made from stainless-steel materials.

In one of the embodiments, the driving unit further comprises a shaft sleeve, a first oblique wedge disc, a second oblique wedge disc, and a clamp spring, the first oblique wedge disc is mounted on the main body, the second oblique wedge disc is mounted on the button, the first oblique wedge disc is arranged to be opposite to the second oblique wedge disc, the other end of the driving shaft extends through the main body, the first oblique wedge disc, the second oblique wedge disc, and the button in sequence, a clamp slot is arranged on an extended segment, the clamp spring is inserted into the clamp slot to limit the button, the shaft sleeve is sleeved on the driving shaft and fixed to the main body, and a reset spring is arranged between the shaft sleeve and the cone disc.

In one of the embodiments, the cutting unit comprises a cutter wheel shaft, a cutter wheel shaft sleeve, a supporting wheel, and a cutter wheel, a mounting slot is arranged on the main body, the cutter wheel shaft crosses the mounting slot, the cutter wheel shaft sleeve, the supporting wheel, and the cutter wheel are respectively arranged in the mounting slot and sleeved on the cutter wheel shaft, the cutter wheel and the supporting wheel are respectively made by a stamping process, and the cutter wheel shaft sleeve is made from engineering plastics.

In one of the embodiments, the first oblique wedge disc has a first oblique wedge surface, a first oblique wedge boss is arranged on the first oblique wedge surface, the second oblique wedge disc has a second oblique wedge surface, the second oblique wedge surface is arranged to be opposite to the first oblique wedge surface, a second oblique wedge boss corresponding to the first oblique wedge boss is arranged on the second oblique wedge surface, and both the first oblique wedge disc and the second oblique wedge disc are made by a stamping process.

In one of the embodiments, a gasket is further sleeved on the driving shaft and located between the clamp spring and the button.

In one of the embodiments, the extended segment of the driving shaft is connected to a knob.

In one of the embodiments, the button edge-cutting can opener further comprises a handheld handle, which is connected to the main body.

In one of the embodiments, the handheld handle has a plug-in portion, a plug-in slot is arranged on the main body, and the plug-in portion is inserted into the plug-in slot to fix the handheld handle to the main body in a plug-in manner.

### Beneficial Effects

1. as the button is rotatably connected to the main body and provided with a pressing portion, one can rotate the button by pushing the pressing portion upward or pressing it downward with a thumb, which drives the driving unit to move axially, locks or unlocks a canned product, thereby making it easy and convenient to operate the can opener;
2. as an operation identification unit is mounted on the main body, the use and positions of the two groups of identification positioning backup plates (at the top portion of the can edge of the can lid) during the operation of opening a can be known through the arc-shaped end portions of the two groups of identification positioning backup plates in the operation identification unit, so as to ensure that a user knows how to lock the can at a glance, and further make it easy for the user to learn and master.
3. a boss is arranged on the cone disc, 28 to 36 gear teeth are distributed on a side wall of the boss in an evenly spaced manner, an end portion of each of the gear teeth extends towards the cone disc, and a smooth surface is formed between the extending end portion and an edge of the cone disc; by reducing the number of the gear teeth to 28 to 36, the teeth marks generated by front and rear gear teeth can overlap when the cone rod rotates, thereby reducing displacement and sliding; as such, iron filings that fall from the can edge of the scratched can lid are effectively reduced; at the same time, since the gear teeth each have a relatively short extending end, a smooth surface is formed between the extending end and the edge of the cone disc; through the smooth surface, the situation of scratching the can edge of the can lid can be alleviated, so as to reduce the generation of iron filings and ensure the food safety.

### BRIEF DESCRIPTION OF THE DRAWINGS

FIG. 1 is a structure diagram of a button edge-cutting can opener in the present invention;

FIG. 2 is an exploded view of a button edge-cutting can opener in the present invention;

FIG. 3 is a cutaway view of a button edge-cutting can opener in the present invention;

FIG. 4 is a structure diagram of a cone rod of a button edge-cutting can opener in the present invention;

FIG. 5 is a structure diagram of a main body of a button edge-cutting can opener in the present invention;

FIG. 6 is a collaboration diagram of a first oblique wedge disc and a second oblique wedge disc of a button edge-cutting can opener in the present invention;

FIG. 7 is a structure diagram of a cutter wheel of a button edge-cutting can opener in the present invention;

FIG. 8 is a usage state diagram of a button edge-cutting can opener in the present invention;

FIG. 9 is a usage state top view of a button edge-cutting can opener in the present invention;

FIG. 10 is a usage state side view of a button edge-cutting can opener in the present invention;

FIG. 11 is a diagram of teeth marks generated by the rotation of a cone rod of a button edge-cutting can opener in the present invention;

FIG. 12 is a diagram of a cone rod of a can opener in the prior art;

FIG. 13 is a diagram of teeth marks generated by the rotation of a cone rod of a can opener in the prior art.

As shown in the figures:
100. main body; 110. mounting slot; 120. plug-in slot;
200. button; 210. pressing portion;
300. drive unit; 310. cone rod; 311. driving shaft; 312. cone disc; 313. boss; 314. gear tooth; 315. smooth surface; 316. clamp slot; 320. shaft sleeve; 330. first oblique wedge disc; 331.
first oblique wedge surface; 332. first oblique wedge boss; 340. second oblique wedge disc; 341. second oblique wedge surface; 342. second oblique wedge boss; 350. clamp spring; 360. reset spring; 370. gasket; 380. knob;
400. cutting unit; 410. cutter wheel shaft; 420. cutter wheel shaft sleeve; 430. supporting wheel; 440. cutter wheel; 441. rotating portion; 442. cutter portion;
500. operation identification unit; 510. identification positioning backup plate; 511. reinforming member; 520. abutment plate;
600. handheld handle; 610. plug-in portion;
700. can; 710. can lid; 711. can edge.

### DESCRIPTION OF THE EMBODIMENTS

To make the above objectives, features, and advantages of the present invention clearer, the specific manners of implementation of the present invention will be described below in detail in combination with the drawings. Many specific details are elaborated in the following illustrations to facilitate a thorough understanding of the present invention. However, the present invention can be carried out in many other ways different from described herein, and those skilled in the art can make similar improvements without departing from the scope of the present invention. Therefore, the present invention is not limited by the specific embodiments disclosed below.

It should be noted that when it is stated that a component is “fixed to” another component, it can be directly on another component or there can be an intermediate component. When a component is considered to be “connected” to another component, it can be directly connected to another component or there may exist an intermediate component at the same time. On the contrary, when it is stated that a component is “directly” “on” another component, there is no intermediate component. The terms “vertical”, “horizontal”, “left”, “right” and similar expressions used in the present text are for illustrative purposes only.

Unless otherwise defined, all the technical and scientific terms used in the present text have the same meanings as those commonly understood by persons skilled in the technical field to which the present invention pertains. The terms used in the description of the present invention are only for the purpose of describing the specific manners of implementation, and are not intended to limit the present invention. The term “and/or” used in the present text includes any and all combinations of one or more relevant items as listed.

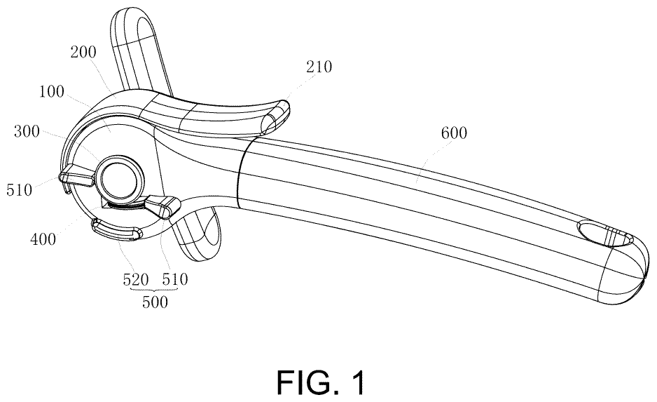

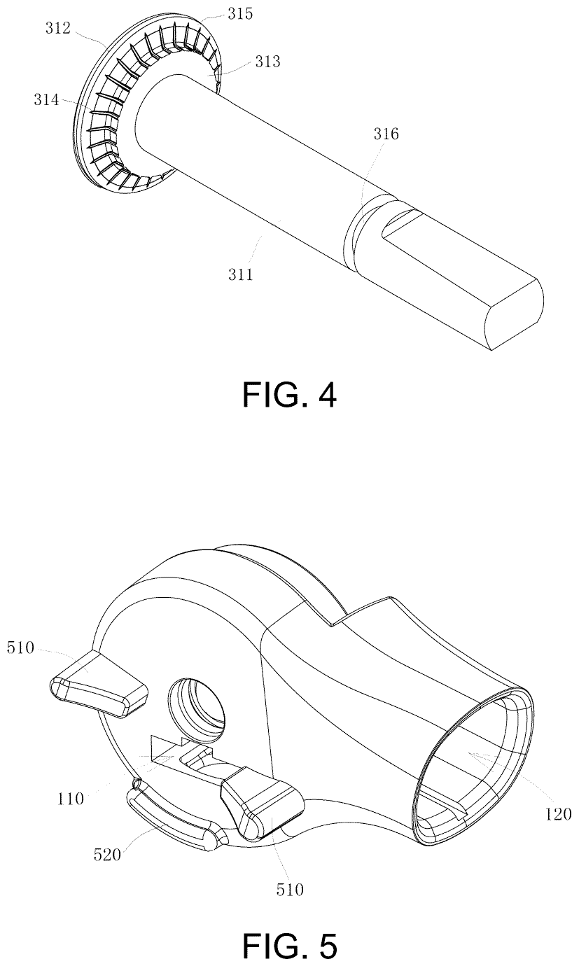

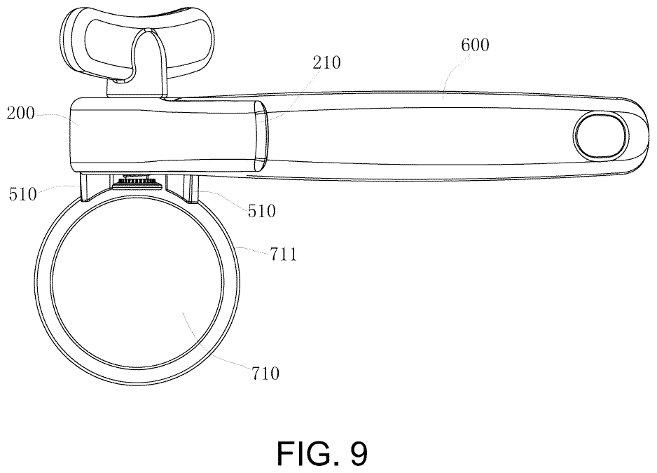

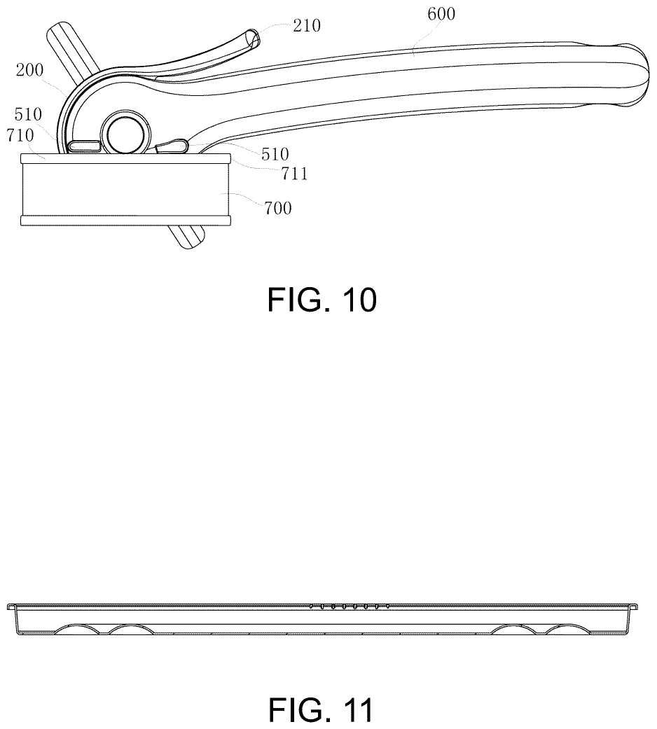

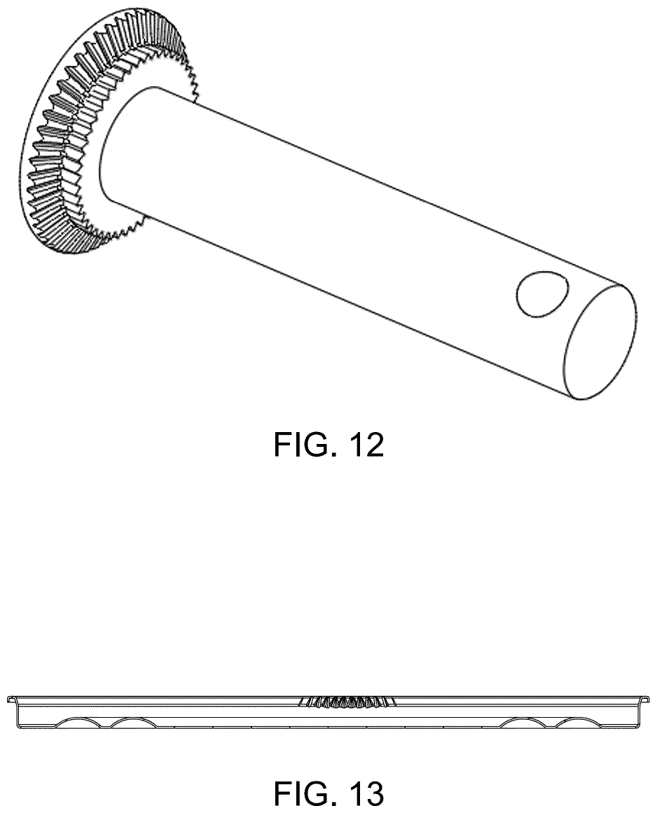

With reference to FIGS. 1 to 13, a button edge-cutting can opener comprises a main body 100, a button 200, a driving unit 300, and a cutting unit 400; the button 200 is rotatably connected to the main body 100 through the driving unit 300 and is provided with a pressing portion 210; the cutting unit 400 is mounted on the main body 100 and kept in a state of engaging with the driving unit 300; the driving unit 300 comprises a cone rod 310, which has a driving shaft 311 and a cone disc 312; the cone disc 312 is connected to one end of the driving shaft 311, and a boss 313 is arranged on the cone disc 312; 28 to 36 gear teeth 314 are distributed on a side wall of the boss 313 in an evenly spaced manner; an end portion of each of the gear teeth 314 extends towards the cone disc 312, and a smooth surface 315 is formed between the extending end portion and an edge of the cone disc 312.

Specifically, in the present embodiment, the button 200 is rotatably connected to the main body 100, and a pressing portion 210 is arranged on the button 200; in the course of operating the button edge-cutting can opener, a user pushes the pressing portion 210 upward or presses it downward with his or her thumb, so as to rotate the button 200 relative to the main body 100, and further drive the driving unit 300 to move axially, and lock or unlock a can 700 product, which realizes one-handed operation, and makes it simple and convenient to operate the button edge-cutting can opener; moreover, the button edge-cutting can opener in the present invention can be formed by creatively shortening an upper handle of the double-handle edge-cutting can opener in the prior art, transforming it into the button 200, and arranging the pressing portion 210 on the button 200, which makes the structure thereof simple and the design reasonable.

In addition, a boss 313 is arranged on the cone disc 312; 28 to 36 gear teeth 314 are distributed on a side wall of the boss 313 in an evenly spaced manner; an end portion of each of the gear teeth 314 extends towards the cone disc 312; a smooth surface 315 is formed between the extending end portion and an edge of the cone disc 312. The end portion of each of the gear teeth 314 extends towards the cone disc 312, and its extended end forms a smooth surface 315 with the edge of the cone disc 312. By reducing the number of the gear teeth 314 to 28 to 36, the teeth marks generated by the front and rear gear teeth 314 can overlap when the cone rod 310 rotates, thereby reducing displacement and sliding; as such, the iron filings that fall from the can edge 711 of the scratched can lid 710 are effectively reduced; at the same time, since the gear teeth 314 each have a relatively short extending end, the smooth surface 315 is formed between the extending end and the edge of the cone disc 312; through the smooth surface 315, the situation of scratching the can edge 711 of the can lid 710 can be alleviated, so as to reduce the generation of iron filings and ensure the food safety.

Moreover, the gear teeth 314 extending to the cone disc 312 is set to have a height of about 0.1 mm. By controlling the height of the gear teeth 314 within this range, the depth of the teeth marks left by the gear teeth 314 can be limited in the course of opening a can, which avoids both overly deep teeth marks that lead to excessive iron filings and overly shallow teeth marks that fall short of the required friction force, so that the gear teeth 314 can open the can normally and reduce the generation of iron filings, thereby ensuring the food safety.

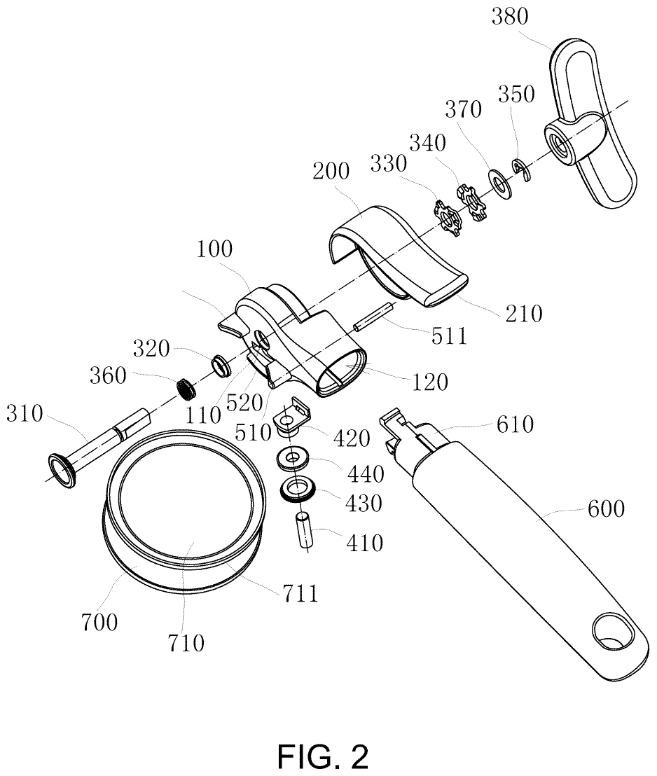

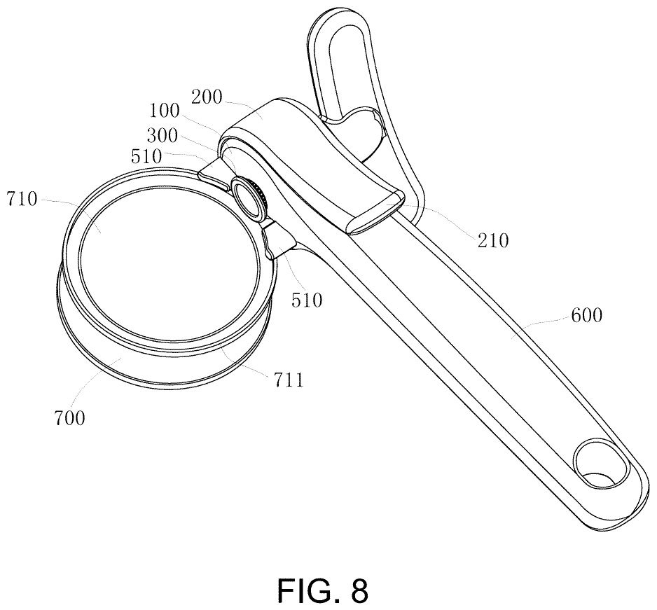

With reference to FIG. 1, FIG. 2, FIG. 5, and FIGS. 8 to 10, to facilitate operating the button edge-cutting can opener, in the present embodiment, an operation identification unit 500 is arranged on the main body 100; the operation identification unit 500 comprises identification positioning backup plates 510 and an abutment plate 520; the identification positioning backup plates 510 are arranged in two groups, which are respectively located on both sides of the cone disc 312; moreover, the two groups of identification positioning backup plates 510 are arranged to be opposite to each other and have end portions in an arc shape.

Instead of the U-shaped auxiliary positioning backup ring in the prior art, an operation identification unit 500 is designed. Moreover, the operation identification unit 500 comprises two groups of identification positioning backup plates 510 and an abutment plate 520. In the course of opening the can 700 product, the two groups of identification positioning backup plates 510 are respectively pressed against the top portion of the can edge 711 of the can lid 710, and the abutment plate 520 is pressed against the side wall of the can 700 product. Then, the thumb acts on the pressing portion 210 to drive the driving unit 300 to move in an axial direction, which can lock the can 700 product and achieve the function of auxiliary positioning identification. This makes it easy and simple to operate the button edge-cutting can opener during use. In addition, two groups of identification positioning backup plates 510 are respectively arranged on both sides of the cone disc 312, and the end portions of the two groups of identification positioning backup plates 510 are arranged in an arc shape. Through the design of the arc-shaped end portions, a user can better identify the use and positions of the two groups of identification positioning backup plates 510 when performing the can-opening operation on the can 700 product, so that the user can learn how to use at a glance when using it for the first time, thereby ensuring that the user finds it easy to learn and master, and can better use the button edge-cutting can opener in the present embodiment.

Of course, since the identification positioning backup plates 510 need to abut against the can lid 710 during use and are made from plastic materials, to improve the strength of the identification positioning backup plates 510, a reinforcement member 511 is arranged inside the identification positioning backup plates 510 and made from stainless steel materials. Through the reinforcement member 511, the overall strength of the identification positioning backup plates 510 can be improved, so as to ensure the auxiliary function of the button edge-cutting can opener.

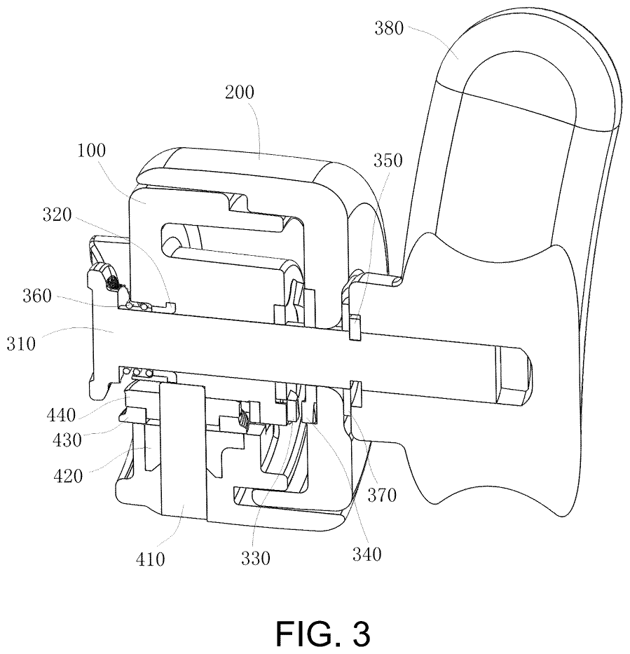

With reference to FIGS. 2 and 3, the driving unit 300 in the present embodiment further comprises a shaft sleeve 320, a first oblique wedge disc 330, a second oblique wedge disc 340, and a clamp spring 350; the first oblique wedge disc 330 is mounted on the main body 100, and the second oblique wedge disc 340 is mounted on the button 200; the first oblique wedge disc 330 and the second oblique wedge disc 340 are arranged to be opposite to each other; the other end of the driving shaft 311 extends through the main body 100, the first oblique wedge disc 330, the second oblique wedge disc 340, and the button 200 in sequence, and a clamp slot 316 is arranged on an extended segment; the clamp spring 350 is inserted into the clamp slot 316 to limit the button 200 and the main body 100; the shaft sleeve 320 is sleeved on the driving shaft 311 and fixed to the main body 100; a reset spring 360 is arranged between the shaft sleeve 320 and the cone disc 312.

By arranging a shaft sleeve 320 in the driving unit 300 and sleeving the shaft sleeve 320 on the driving shaft 311 while the shaft sleeve 320 is made from wear-resistant metal materials, the driving shaft 311 can be effectively protected from excessive wear caused by the rotation of the driving shaft 311, so as to improve the service life of the cone rod 310, slow down the loss of the can-opening function caused by the displacement of the driving shaft 311 due to wear, and reduce the cost. Moreover, the shaft sleeve 320 is made by a stamping process, which can reduce the processing cost and improve the processing efficiency.

In the course of cutting the can lid 710 of the can 700 product, a user pushes the pressing portion 210 upward with a thumb to open the button 200 and the main body 100. In the opening course, through the first oblique wedge disc 330 and the second oblique wedge disc 340, the cone rod 310 and the main body 100 can move axially in a manner of facing each other, which increases the engaging distance between the driving unit 300 and the cutting unit 400. At this time, the can edge 711 of the can lid 710 of the can 700 product is placed between the cone disc 312 and the cutter wheel 440 of the cutting unit 400 along the abutment plate 520. Then, the user presses the pressing portion 210 with a thumb to close the button 200 and the main body 100. Through the first oblique wedge disc 330 and the second oblique wedge disc 340, the cone rod and the main body 100 move axially in a manner of facing away from each other, which reduces the engaging distance between the driving unit 300 and the cutting unit 400 and tightens the can edge 711 of the can lid 710. At this time, the cone rod 310 is rotated, so that the cutting unit 400 cuts around the can edge 711 of the can lid 710 until the cutting is completed. Moreover, through the engagement between the driving unit 300 and the cutting unit 400, the cut can lid 710 can be directly lifted. After lifting, the thumb can push the pressing portion 210 upward to open the button 200 and the main body 100. Through the first oblique wedge disc 330, the second oblique wedge disc 340, and the reset pressure spring 360, the cone rod 310 and the button 200 can be moved in a manner of facing each other again to increase the engaging distance between the cone disc 312 and the cutting unit 400, so that the cut can lid 710 can fall off.

To facilitate driving the cone rod 310 to rotate, a knob 380 is connected to the extended segment of the driving shaft 311. The knob 380 can facilitate the user rotating the cone rod 310, thereby facilitating cutting the can lid. In addition, to reduce the wear between the knob 380 and the button 200, a gasket 370 is further sleeved on the driving shaft 311. The gasket 370 is located between the clamp spring 350 and the button 200. Through the gasket 370, the wear caused by the rotation of the knob 380 can be effectively reduced, so as to improve the overall service life of the button edge-cutting can opener.

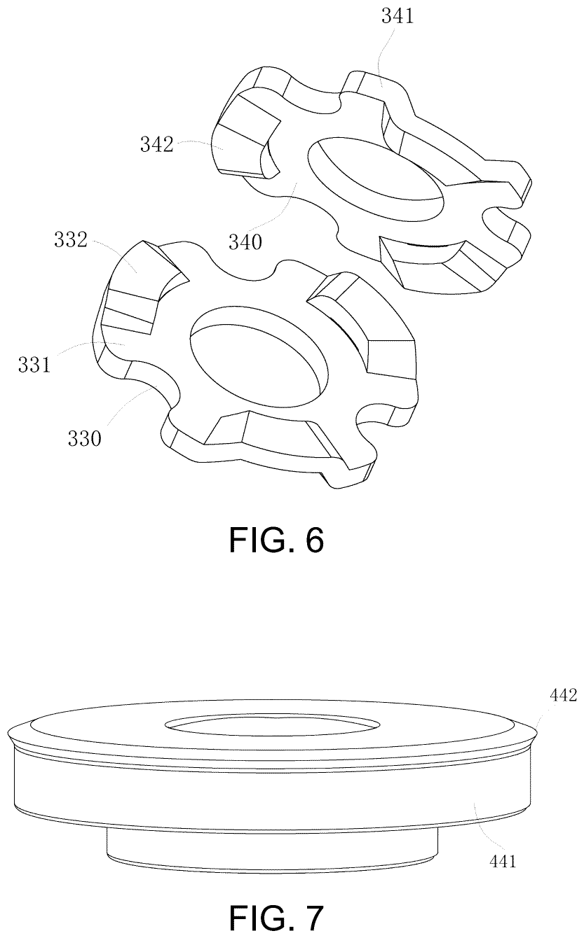

Further, with reference to FIG. 6, to ensure the axial movement of the driving unit 300 relative to the main body 100, the first oblique wedge disc 330 in the present embodiment has a first oblique wedge surface 331, and a first oblique wedge boss 332 is arranged on the first oblique wedge surface 331; the second oblique wedge disc 340 has a second oblique wedge surface 341, which is arranged to be opposite to the first oblique wedge surface 331; a second oblique wedge boss 342 corresponding to the first oblique wedge boss 332 is arranged on the second oblique wedge surface 341.

By replacing the existing first oblique wedge disc 330 and second oblique wedge disc 340 made by powder metallurgy processing with those made by the stamping process and adopting split-type assembly between the first oblique wedge disc 330 and the main body 100 and between the second oblique wedge disc 340 and the button 200, the processing of the first oblique wedge disc 330 and the second oblique wedge disc 40 can be facilitated, and the processing accuracy thereof can be improved. At the same time, the overall production cost of the button edge-cutting can opener can be reduced, and the service life thereof can be prolonged. After the pressing portion 210 is pushed to open the button 200 and the main body 100, the first oblique wedge boss 332 of the first oblique wedge disc 330 will be separated from the second oblique wedge boss 342 of the second oblique wedge disc 340, which makes the cone rod 310 move axially. When the pressing portion 210 is pressed to close the button 200 and the main body 100, the first oblique wedge boss 332 of the first oblique wedge disc 330 will abut against the second oblique wedge boss 342 of the second oblique wedge disc 340, which makes the cone rod 310 move axially again and compress the reset pressure spring 360 to achieve the engagement between the driving unit 300 and the cutting unit 400. In this way, the cutting of the can edge 711 of the can lid 710 of the can 700 product is realized.

With reference to FIGS. 2, 3, and 7, to cut a canned product, the cutting unit 400 in the present embodiment comprises a cutter wheel shaft 410, a cutter wheel shaft sleeve 420, a supporting wheel 430, and a cutter wheel 440; a mounting slot 110 is arranged on the main body 100; the cutter wheel shaft 410 crosses the mounting slot 110; the cutter wheel shaft sleeve 420, the supporting wheel 430, and the cutter wheel 440 are respectively arranged in the mounting slot 110 and sleeved on the cutter wheel shaft 410; the cutter wheel 440 comprises an integrated rotating portion 441 and a cutter portion 442; the cutter portion 442 is located at one end of the rotating portion 441, and protrudes outward.

By arranging the cutter wheel shaft sleeve 420, the supporting wheel 430, and the cutter wheel 440 respectively in the mounting slot 110 of the main body 100, fixing them with the cutter wheel shaft 410, and coordinating the cutter wheel 440 with the cone disc 312 of the cone rod 310, the cutting of can lid 710 of the can 700 product can be realized. At the same time, the original cutter wheel 440 is disassembled into a split-type cutter wheel 440 and a supporting wheel 430, and the cutter wheel 440 is made by stamping processing and then lathe processing, which can facilitate the processing of the cutter wheel 440. The cutter wheel shaft sleeve 420 is made from engineering plastics with good wear resistance and high strength, and the cutter wheel shaft sleeve 420 is sleeved on the cutter wheel shaft 410, which can effectively reduce the wear speed with the cutter wheel shaft 410, so as to slow down the loss of the can-opening function caused by the displacement of the cutter wheel shaft 410 due to wear. In this way, the service life of the cutter wheel shaft 410 is prolonged, and the processing cost can be reduced.

Finally, with reference to FIG. 1 or FIG. 2, to facilitate using the can opener, the button edge-cutting can opener in the present embodiment further comprises a handheld handle 600; the handheld handle 600 has a plug-in portion 610, and a plug-in slot 120 is arranged on the main body 100; in the course of mounting the handheld handle 600 and the main body 100, the plug-in portion 610 of the handheld handle 600 can be directly inserted into the plug-in slot 120 of the main body 100 to realize the plug-in fixation between the handheld handle 600 and the main body 100; moreover, the handheld handle 600 can facilitate the user holding the button edge-cutting can opener, followed by pushing or pressing the pressing portion 210 of the button 200 with a thumb, thereby achieving one-handed operation, and further making it simple and convenient to operate the button edge-cutting can opener.

The above content displays and describes the basic principles, main features, and advantages of the present invention. Persons skilled in the art can smoothly implement the present invention according to the drawings and the content as described above. However, any equivalent changes of alterations, modifications, and evolutions that are made by persons skilled in the art by using the technical content disclosed above without departing from the scope of the technical solution of the present invention are equivalent embodiments of the present invention. Meanwhile, the alterations, modifications, and evolutions of any equivalent changes that are made to the above embodiments based on the essential technology of the present invention still fall within the scope of protection of the technical solution of the present invention.

What is claimed is:

1. A button edge-cutting can opener, comprising:
a main body, a button, a driving unit, and a cutting unit, wherein the button is rotatably connected to the main body through the driving unit and provided with a pressing portion, the cutting unit is mounted on the main body and kept in a state of engaging with the driving unit;
the driving unit comprises a cone rod, which has a driving shaft and a cone disc, the cone disc is connected to one end of the driving shaft, a boss is arranged on the cone disc, 28 to 36 gear teeth are distributed on a side wall of the boss in an evenly spaced manner, an end portion of each of the gear teeth extends towards the cone disc, and a smooth surface is formed between an extending end portion and an edge of the cone disc.

2. The button edge-cutting can opener of claim 1, wherein an operation identification unit is arranged on the main body, the operation identification unit comprises identification positioning backup plates and an abutment plate, the identification positioning backup plates are arranged in two groups, which are respectively located on both sides of the cone disc, and the two groups of identification positioning backup plates are arranged to be opposite to each other and have end portions in an arc shape.

3. The button edge-cutting can opener of claim 2, wherein a reinforcement member is arranged inside the identification positioning backup plates and made from stainless-steel materials.

4. The button edge-cutting can opener of claim 1, wherein the driving unit further comprises a shaft sleeve, a first oblique wedge disc, a second oblique wedge disc, and a clamp spring, the first oblique wedge disc is mounted on the main body, the second oblique wedge disc is mounted on the button, the first oblique wedge disc is arranged to be opposite to the second oblique wedge disc, an other end of the driving shaft extends through the main body, the first oblique wedge disc, the second oblique wedge disc, and the button in sequence, a clamp slot is arranged on an extended segment, the clamp spring is inserted into the clamp slot to limit the button, the shaft sleeve is sleeved on the driving shaft and fixed to the main body, and a reset spring is arranged between the shaft sleeve and the cone disc.

5. The button edge-cutting can opener of claim 1, wherein the cutting unit comprises a cutter wheel shaft, a cutter wheel shaft sleeve, a supporting wheel, and a cutter wheel, a mounting slot is arranged on the main body, the cutter wheel shaft crosses the mounting slot, the cutter wheel shaft sleeve, the supporting wheel, and the cutter wheel are respectively arranged in the mounting slot and sleeved on the cutter wheel shaft, the cutter wheel and the supporting wheel are respectively made by a stamping process, and the cutter wheel shaft sleeve is made from engineering plastics.

6. The button edge-cutting can opener of claim 4, wherein the first oblique wedge disc has a first oblique wedge surface, a first oblique wedge boss is arranged on the first oblique wedge surface, the second oblique wedge disc has a second oblique wedge surface, the second oblique wedge surface is arranged to be opposite to the first oblique wedge surface, a second oblique wedge boss corresponding to the first oblique wedge boss is arranged on the second oblique wedge surface, and both the first oblique wedge disc and the second oblique wedge disc are made by a stamping process.

7. The button edge-cutting can opener of claim 4, wherein a gasket is further sleeved on the driving shaft and located between the clamp spring and the button.

8. The button edge-cutting can opener of claim 4, wherein the extended segment of the driving shaft is connected to a knob.

9. The button edge-cutting can opener of claim 1, wherein the button edge-cutting can opener further comprises a handheld handle, which is connected to the main body.

10. The button edge-cutting can opener of claim 9, wherein the handheld handle has a plug-in portion, a plug-in slot is arranged on the main body, and the plug-in portion is inserted into the plug-in slot to fix the handheld handle to the main body in a plug-in manner.
